(19) United States
(12) Patent Application Publication
(10) Pub. No.: US 2016/0050209 A1
(43) Pub. Date: Feb. 18, 2016

(54) ACCESS CONTROL BASED ON AUTHENTICATION

(71) Applicant: EBAY INC., San Jose, CA (US)

(72) Inventors: Shailesh Dinkar Govande, Milpitas, CA (US); Madhura Pravin Tipnis, Milpitas, CA (US)

(21) Appl. No.: 14/461,834

(22) Filed: Aug. 18, 2014

(51) Int. Cl. H04L 29/06

(52) U.S. Cl. CPC H04L 63/101; H04L 63/083

(57) ABSTRACT

Systems and methods for granting access to different applications and/or functionalities on a user device based on at least a length of authentication provided by a user are described. A user preconfigures an authentication control program by establishing two or more authentications that are of different length or type from each other, and associates each authentication with a level of access. When the user provides a valid authentication for full access to unlock the user device, the user is granted access to all applications on the user device. When the user enters a valid authentication for partial access, the user is granted varying levels of access to applications on the user device depending on the length or type of the authentication.

### BACKGROUND

1. Field of the Invention

The present invention generally relates to access control on a user device based on length and/or type of authentication.

2. Related Art

Typically, user devices such as mobile devices use an “all-or-nothing” model of access, in which a user is required to enter a password each time to unlock a device and access applications and functionalities on the device. If the user enters the correct full password, the user has access to all applications and functionalities on the device, but if the user misses the password even by one digit or character, the user does not have access to any of the applications or functionalities, except perhaps emergency calling or glancing at notifications (e.g., Active Display on Moto X™ from Motorola®). The password to unlock a device may be long based on the password policy that is enforced. For example, an employer may enforce a password policy that requires a long password (e.g., 8 or more digits/characters) on a mobile device of an employee because the mobile device has company-related information or access to company email. In such cases, it becomes tedious to enter the full password for simple tasks, such as checking a text message or turning on music. To avoid this, some users go to the other extreme of the “all-or-nothing” model, in which no password is required to access the applications and functionalities on a device. However, not requiring a password for unlocking the device creates a security risk.

### BRIEF DESCRIPTION OF THE FIGURES

FIG. 1 is a block diagram illustrating a system for access control on a user device based on a length or type of authentication according to an embodiment of the present disclosure;

FIG. 2 is an illustration of a user entering in a password on a user device according to an embodiment of the present disclosure;

FIG. 3 is a flowchart showing a method for access control based on a length or type of authentication according to an embodiment of the present disclosure;

FIG. 4 is a flowchart showing a method for granting tiered access based on a length of a password according to an embodiment of the present disclosure; and

FIG. 5 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for granting access to different applications and/or functionalities on a user device based on a length or type of authentication, such as a length of a password. A user establishes on a user device two or more authentications that are of different length or type from each other, and associates each authentication with a level of access to applications and/or functionalities. The established authentications may include, for example, a full password and partial passwords (e.g., the first 2 digits/characters of the full password).

When the user subsequently provides an authentication to unlock the user device, an application control program provides tiered access by determining a level of access to be granted based on the length or type of the provided authentication. In an exemplary embodiment, the application control program grants access to applications and/or functionalities that are accessible at an access level based on at least a length of authentication. For example, if the full password is “hambu4g34s” and a user enters only “hambu,” the user is only granted partial access. On the other hand, if the user enters “hambu4g34s,” he or she is granted full access. The access control program may be a part of an operating system or a separate application on the user device.

In various embodiments, a user device may be unlocked using one or more methods of authentication. The methods of authentication may include, for example, entering a password (e.g., an alphanumeric password, personal identification number (PIN), or passphrase), drawing a swipe pattern, tapping a pattern, scanning a fingerprint or a retinal pattern, recognizing a voice or a face, etc. For each method of authentication, the user provides a corresponding type of authentication to verify that he or she has access rights to the user device. The authentication types may include a password (e.g., alphanumeric password, PIN, or passphrase), swipe pattern, tap pattern, biometrics (e.g., fingerprint, retinal pattern, voice, or face shape), etc. The method of authentication may also require a combination of authentication types. For example, if the method of authentication includes a password and a swipe pattern for full access, the user is required to enter the password and the swipe pattern to be granted full access.

In many embodiments, a user controls methods of authentication, access control rules, and categorization of applications and/or functionalities through user settings/configuration. The user may configure the access control program by an initial configuration that the user is guided through when the user first uses the user device, or under the user settings/configuration menu of the user device.

The user settings/configuration may include establishing and/or selecting authentications. For example, the user may establish a password authentication by entering and confirming a password. In another example, the user may establish a fingerprint authentication by scanning one or more fingers several times on a fingerprint identity sensor. The established authentications may be for full access, or for partial access. The access control program may store the established authentication information on the user device or on a service provider server.

The user settings/configuration may include access control rules. The user may establish and/or select access control rules by presetting one or more levels of access and associating each established authentication with one of the preset access levels. The preset access levels may include a full access level and one or more partial access levels. The established authentications for full access are associated with the full access level, while the established authentications for partial access are associated with one of the partial access levels. When the user provides one of the established authentications, the access control program grants access at the preset access level that is associated with that established authentication. In an embodiment, the applications and functionalities are predetermined to be accessible or inaccessible at each of the preset access levels.

The user settings/configuration may further include grouping applications and/or functionalities into categories, and associating each category with an access level. In one embodiment, the user groups applications and/or functionalities into different categories that are predetermined by the user. In other embodiments, the user selects a default categorization (e.g., financial applications, social networking applications, games, etc.), which may be customizable. The user associates each category to an access level, which is in turn associated with one or more established authentications. Thus, access to applications and/or functionalities in each category is based on the length and/or type of the provided authentication.

In various embodiments, the access control program grants access to different applications on a user device based on the length or type of the authentication provided by a user. The user may associate specific applications with an access level. For example, the user may associate financial applications with a full access level that requires the full password for access, since the financial applications contain sensitive financial information. In another example, the user may associate games with a basic access level that requires the first 2 digits/characters of the full password, since games do not contain any private or sensitive information. In a further example, a user may associate social networking applications, such as Twitter, with an access level that requires the first 4 digits/characters of the full password. An access level may require a partial password of a determined length (e.g., the first 2 digits/characters) or allow partial passwords within a range of lengths (e.g., 2-3 digits/characters).

In several embodiments, the access control program grants access to different functionalities on a user device based on the length or type of the authentication provided by a user. The functionalities on the user device may include, for example, basic phone functionalities, such as texting via Short Message Service (SMS) and calling, and/or features of an application or site, such as reading and composing an email on an email application. The user may associate a specific functionality with an access level. In an example, the functionality of reading recent emails on an email application may be associated with a basic access level that requires the first 2 digits/characters of the full password, but access to the functionality of composing and sending emails may be associated with an intermediate access level that requires the first 4 digits/characters of the full password. In another example, the user may associate the basic phone functionalities of calling and/or SMS texting with a basic access level that requires the first 2 digits/characters of the full password.

It is advantageous to have a simple authentication for basic phone functionalities in emergency situations in which it is difficult for a user to make a call on a mobile device but is able to send an emergency SMS text. Typically, SMS texting is only available if the mobile device is unlocked with the full password, which may waste valuable time in an emergency situation. By using the access control program, the user can unlock the mobile device with the first 2 digits/characters to send an emergency SMS text in a shorter period of time.

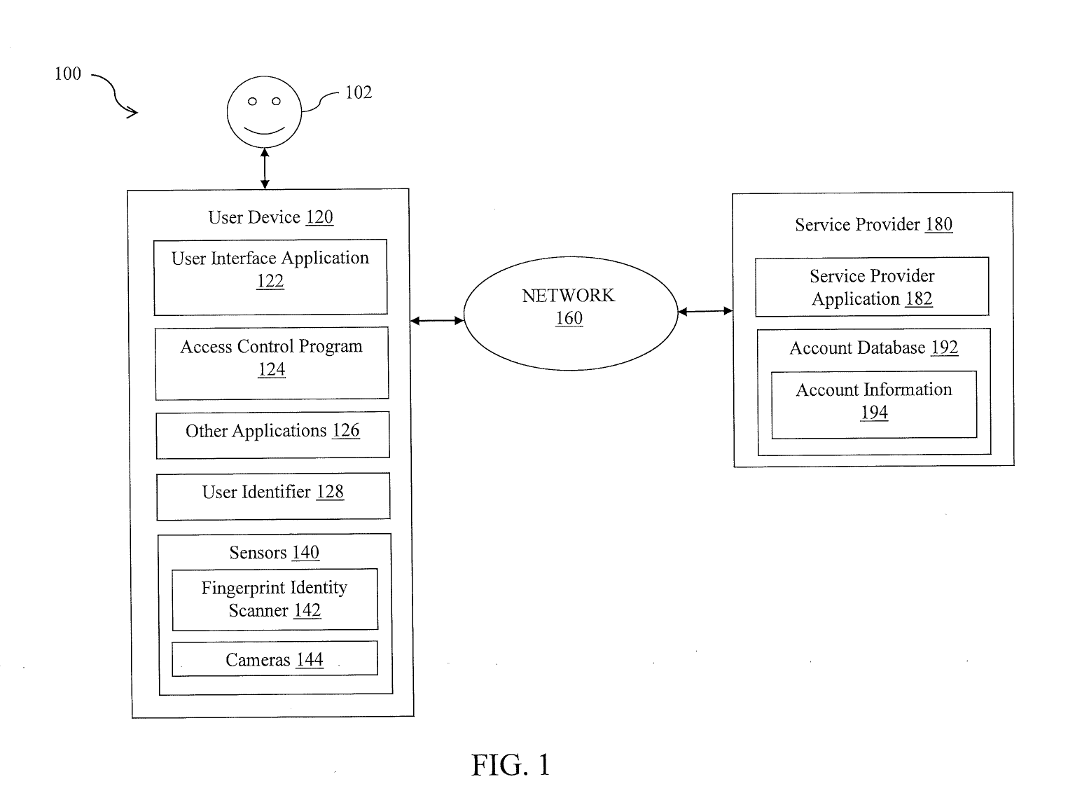

FIG. 1 shows one embodiment of a block diagram of a network-based system 100 that includes a user device 120 configured to provide access control on a user device based on length or type of authentication according to an embodiment of the present disclosure. As shown, system 100 may comprise or implement a plurality of servers and/or software components that operate to perform various methodologies in accordance with the described embodiments. Exemplary servers may include, for example, stand-alone and, enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, system 100 includes user device 120 (e.g., a smartphone) and at least one service provider server or device 180 (e.g., network server device) in communication over a network 160. Network 160, in one embodiment, may be implemented as a single network or a combination of multiple networks. For example, in various embodiments, network 160 may include the Internet and/or one or more intranets, landline networks, wireless networks, and/or other appropriate types of communication networks. In another example, network 160 may comprise a wireless telecommunications network (e.g., cellular phone network) adapted to communicate with other communication networks, such as the Internet. As such, in various embodiments, user device 120 and service provider server or device 180 may be associated with a particular link (e.g., a link, such as a URL (Uniform Resource Locator) to an IP (Internet Protocol) address).

User device 120, in one embodiment, may be utilized by a user 102 to interact with service provider server 180 over network 160. For example, user 102 may transmit account information to service provider server 180 via user device 120. In another example, user 102 may conduct financial transactions (e.g., account transfers) with service provider server 180 via user device 120. User device 120, in various embodiments, may be implemented using any appropriate combination of hardware and/or software configured for wired and/or wireless communication over network 160. In various implementations, user device 120 may include at least one of a mobile device, personal computer (PC), laptop computer, smart phone, wireless cellular phone, satellite phone, computing tablet (e.g., iPad™ from Apple®), wearable computing device, smartwatch (e.g., Galaxy Gear™ from Samsung®), eyeglasses with appropriate computer hardware resources (e.g., Google Glass™ from Google®), in-vehicle infotainment system, connected home system, smart television (smart TV), and/or other types of computing devices.

User device 120, in one embodiment, includes a user interface application 122, which may be utilized by user 102 to access applications and functionalities on user device 120, and/or transmit account information to service provider server 180 over network 160. In one aspect, user 102 may login to an account related to user 102 via user interface application 122.

In one implementation, user interface application 122 comprises a software program, such as a graphical user interface (GUI), executable by a processor that is configured to interface and communicate with service provider server 180 via network 160. In another implementation, user interface application 122 comprises a browser module that provides a network interface to browse information available over network 160. For example, user interface application 122 may be implemented, in part, as a web browser to view information available over network 160.

User device 120, in various embodiments, includes an access control program 124. Access control program 124 may be a part of the operating system, a separate application, or a module in another application. For example, access control program 124 may be included in new user devices as a part of the operating system. In another example, access control program 124 is a separate application that user 102 may download and install on user device 120. Access control program 124 may be developed by a service provider and be downloaded to user device 120 from the service provider website. Access control program 124 may require being called by the operating system and/or performed by the operating system before granting user 102 access to a particular application and/or functionality.

In an embodiment, user 102 may preconfigure access control program 124 through a user settings/configuration menu of user device 120 and/or access control program 124. Through the user settings/configuration, user 102 may establish authentications, set access control rules, and/or categorize applications and functionalities. For an initial configuration, user 102 may be guided through the creation and/or selection of valid authentications, access control rules, and/or categories. For example, if access control program 124 is part of the operating system on a new user device, user 102 may activate the new user device, such as by putting in a subscriber identity module (SIM) card and entering credentials for an account with a service provider (e.g., Google® account credentials if on an Android™ operating system). Next, user 102 may be guided through the initial configuration of access control program 124 as part of the preliminary setup of the new user device.

In another example, if access control program 124 is a separate application by itself, user 102 may install access control program 124 on user device 120. User 102 may then open access control program 124 and be guided through an initial configuration of access control program 124. After the initial configuration, user 102 may configure access control program 124 under the user settings/configuration menu. When a new application is installed, user 102 may predetermine accessibility of the new application in the user settings/configuration menu.

In various embodiments, user 102 establishes one or more authentications on access control program 124. The methods used for authentication may include entering a full length password, entering a partial password, entering a swipe pattern, etc. The established authentications may comprise one or more authentications for full access and one or more authentications for partial access.

In some embodiments, access control program 124 provides a two-factor authentication function. The two-factor authentication function allows user 102 to provide a first authentication to access certain applications and/or functionalities, and then a second authentication to gain access to more applications and/or functionalities. When user 102 provides the second authentication, access control program 124 grants access at a higher access level or full access, depending on user configuration/settings. For example, a combination of the first and second authentications may be equivalent to the full password and grant full access.

The first authentication may be, for example, a partial password or a simple swipe (e.g., slide-to-unlock). The second authentication may be a different type of authentication from the first authentication, such as a swipe pattern or a thumbprint. In one embodiment, the second authentication is provided by navigating to a pattern entry screen, for example, in the settings menu, and entering a swipe pattern. In another embodiment, the second authentication is provided by scanning a fingerprint on a fingerprint identity sensor at any time after the first authentication. In a further embodiment, the second authentication is provided by a tap pattern entered on a display of user device 120 that is recognized regardless of which screen is currently presented on the display. User 102 may configure the access control program 124 to accept as valid two or more first and/or second authentications that are of different length or type from each other.

In an example, user 102 enters a partial password on user device 120 and gains access to certain applications. User 102 may then want access to applications and/or functionalities that are not accessible at the current access level. User 102 swipes a pattern to gain access to those applications and/or functionalities. In another example, user 102 unlocks a device with a simple swipe to access certain applications and/or functionalities. User 102 then scans a thumbprint to access more applications and/or functionalities.

In certain embodiments, access control program 124 provides an account login function. The account login function allows user device 120 to automatically login to an account of a user based on the length or type of authentication provided by user 102. User 102 may associate one or more established authentications that provide full access, such as a full password, a full swipe pattern, or a biometric (e.g., a fingerprint on a fingerprint identity sensor), with automatic account login. When user 102 provides one of the full access authentications associated with automatic account login, the access control program 124 automatically logs user 102 into the account and provides access to the account. Typically, a user enters in a password to unlock a user device, and then enters login information to login to an account. Thus, the account login function allows user 102 to accomplish such two-step authentication with only one authentication.

In further embodiments, the account login function allows user 102 to login to an account that is associated with credit card information, banking information, or other types of financial information. For example, user 102 may provide one full authentication to unlock user device 120 and automatically be logged in to an account maintained by a payment service provider, such as PayPal®, Inc. of San Jose, Calif. User 102 may conveniently make purchases online or at a merchant using the account without additional login or authentication.

It is advantageous to allow a user to associate automatic account login with the most secure established authentication. Typically, an account login function on a mobile device, such as web browsers that allow a user to automatically login to user accounts or save login information, are secure only to the extent of the password to unlock the mobile device. Thus, the user must set a long password to make the account login function secure, which makes access to other applications and functionalities inconvenient. By using the account login function in conjunction with the access control program 124, user 102 can establish a secure authentication, such as a long password, for access to the account and establish a simple authentication, such as a simple swipe, for basic phone functionalities.

Access control program 124, in some embodiments, is associated with an account maintained by a service provider. Access control program 124 uploads and/or stores access control information, such as established authentication information, access control rules, categories, etc., on a database maintained by the service provider. The service provider may store the access control information as a part of the user account information. User 102 may configure the user settings/configuration to have the same access control applied to each of the user devices that is logged in with the account. When user 102 logs in to the account in a plurality of user devices, the service provider may transmit the access control information to each user device, for example, at the request of user 102 or automatically by push synchronization, so that each user device provides the same access control. In a further embodiment, each time user 102 changes the user settings/configuration on one user device, the access control information on the service provider server 180 is updated, and the changes are either downloaded or pushed to other devices of user 102.

For example, user 102 may own a smartphone and a tablet that both run the Android operating system from Google®. User 102 may login to both devices with a Google® account, and store access control information on the Google® server. The Google® server may provide the access control information to both devices through automatically syncing the devices or by user download. Every time user 102 changes the user settings/configuration on one device, the access control information on the Google® server is updated, and the changes are either downloaded to the other device or pushed to the other device. In certain embodiments, an established authentication may be a combination of authentication types, such that providing a first authentication type gives partial access, and then providing a second authentication type gives further access. In many embodiments, the access control rules include one or more access levels that may be preset by user 102, and information regarding which applications and/or functionalities are available at each preset access level. In some embodiments, user 102 may predetermine categories of the applications and/or functionalities on access control program 124. Details regarding these embodiments were discussed above.

User device 120, in various embodiments, may include other applications 126 as may be desired in one or more embodiments of the present disclosure to provide additional features available to user 102. In one example, such other applications 126 may include security applications for implementing client-side security features, programmatic client applications for interfacing with appropriate application programming interfaces (APIs) over network 160, and/or various other types of generally known programs and/or software applications. In still other examples, other applications 126 may interface with user interface application 122 for improved efficiency and convenience.

User device 120, in one embodiment, may include at least one user identifier 128, which may be implemented, for example, as operating system registry entries, cookies associated with user interface application 122, identifiers associated with hardware of user device 120, or various other appropriate identifiers. User identifier 128 may include one or more attributes related to user 102, such as personal information related to user 102 (e.g., one or more user names, passwords, photograph images, biometric IDs, addresses, phone numbers, social security number, etc.), banking information, financial information, and/or funding sources (e.g., one or more banking institutions, credit card issuers, user account numbers, security data and information, etc.). In various implementations, user identifier 128 may be passed with a user login request to service provider server 180 via network 160, and user identifier 128 may be used by service provider server 180 to associate user 102 with a particular user account maintained by service provider server 180.

In various embodiments, user device 120 includes one or more sensors 140, such as a fingerprint identity sensor 142 and/or a camera 144. Fingerprint identity sensor 142 may be configured to scan a fingerprint of user 102. Access control program 124 may access fingerprint identity sensor 142 for a fingerprint scan, access established authentication comprising previously stored fingerprint information, and authenticate the fingerprint scan as one belonging to user 102. The fingerprint information may be stored on user device 120, or on service provider server or device 180.

Camera 144 may be configured to capture images, such as an image of a face of user 102 or an eye of user 102. Access control program 124 may access camera 144 for the captured image and identify retina patterns, facial patterns, or other patterns that may be unique to user 102. Access control application 124 may access stored pattern information and authenticate the captured image when the image matches the stored pattern. The pattern information may be stored on user device 120, or on service provider server or device 180.

In various implementations, user 102 is able to input data and information into an input component (e.g., a touchscreen, a keyboard, a microphone, etc.) of user device 120 to provide an authentication to access user device 120 and/or provide user information. The user information may include user identification information.

Service provider server 180, in one embodiment, may be maintained by an online service provider, a payment service provider, an operating system developing entity (e.g., Google®, Apple®, Microsoft®, etc.), or an application developing entity, which may maintain accounts associated with user 102, store user account information and user data, and/or communicate account information with user device 120. As such, service provider server 180 includes a service provider application 182, which may be adapted to interact with user device 120 over network 160 to facilitate access control on user device 120. In one example, service provider server 180 may be provided by PayPal®, Inc. (an eBay® company) of San Jose, Calif., USA. In further examples, service provider server 180 may be provided by the operating system developing entities of the respective user device 120, such as Google® for Android™, Apple® for iOS™, Microsoft® for Windows™, etc.

Service provider server 180, in one embodiment, may be configured to maintain one or more user accounts in an account database 192, each of which may include account information 194 associated with one or more individual users (e.g., user 102). For example, account information 194 may include access control information, such as one or more authentications established by user 102 (e.g., passwords, swipe patterns, tap patterns, fingerprints, biometrics, etc.), user settings/configuration, user authentication information, user access rules, and/or user categories. In another example, account information 194 may also include private financial information of user 102, such as one or more account numbers, passwords, credit card information, banking information, or other types of financial information, which may be used to facilitate financial transactions between user 102 and various service providers or merchants. In various aspects, the methods and systems described herein may be modified to accommodate users that may or may not be associated with at least one existing user account.

In one implementation, user 102 may have identity attributes stored with service provider server 180, and user 102 may have credentials to authenticate or verify identity with service provider server 180. User attributes may include personal information, user established authentications, banking information, financial information, and/or funding sources. In various aspects, the user attributes may be passed to service provider server 180 as part of a login, search, selection, purchase, and/or payment request, and the user attributes may be utilized by service provider server 180 to associate user 102 with one or more particular user accounts maintained by service provider server 180.

Service provider application 182, in one embodiment, maintains the user account information, including access control information. Service provider application 182 may receive access control information, including user settings/configuration, user established authentication information, user access rules, and/or user categories, from user 102 and store access control information on the account database 192. Service provider application 182 may receive account credentials from user device 120 and provide access to the access control information. In an embodiment, user 102 may configure access control program 124 to apply the same access control based on access control information on all of user devices 120 owned by user 102. Service provider application 182 may apply the access control to each user devices 120 by transmitting the access control information at the request of user 102 or automatically by push synchronization.

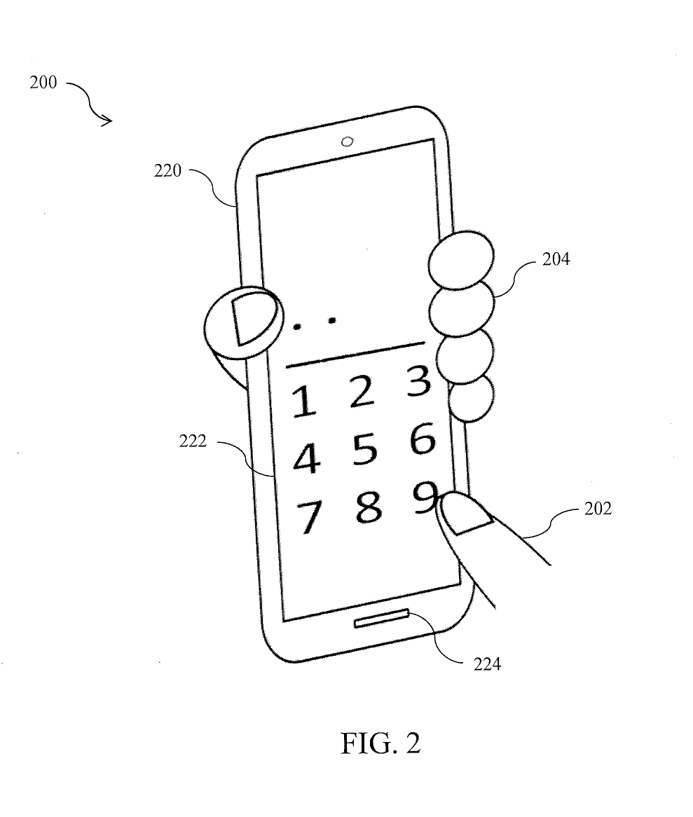

Referring now to FIG. 2, a user finger 202 entering a password, such as a PIN, on a touchscreen 222 of a user device 220 held by a hand of a user 204 is illustrated 200 according to an embodiment of the present disclosure. In an embodiment, user device 220 may present a password entry screen on touchscreen 222 when user 102 presses a button 224, taps touchscreen 222, or speaks into a microphone of user device 220. User 102 enters the password on the password entry screen by tapping touchscreen 222 with user finger 204 to unlock user device 220. User device 220 provides access to certain applications and functionalities depending on the length of the password entered by user 102.

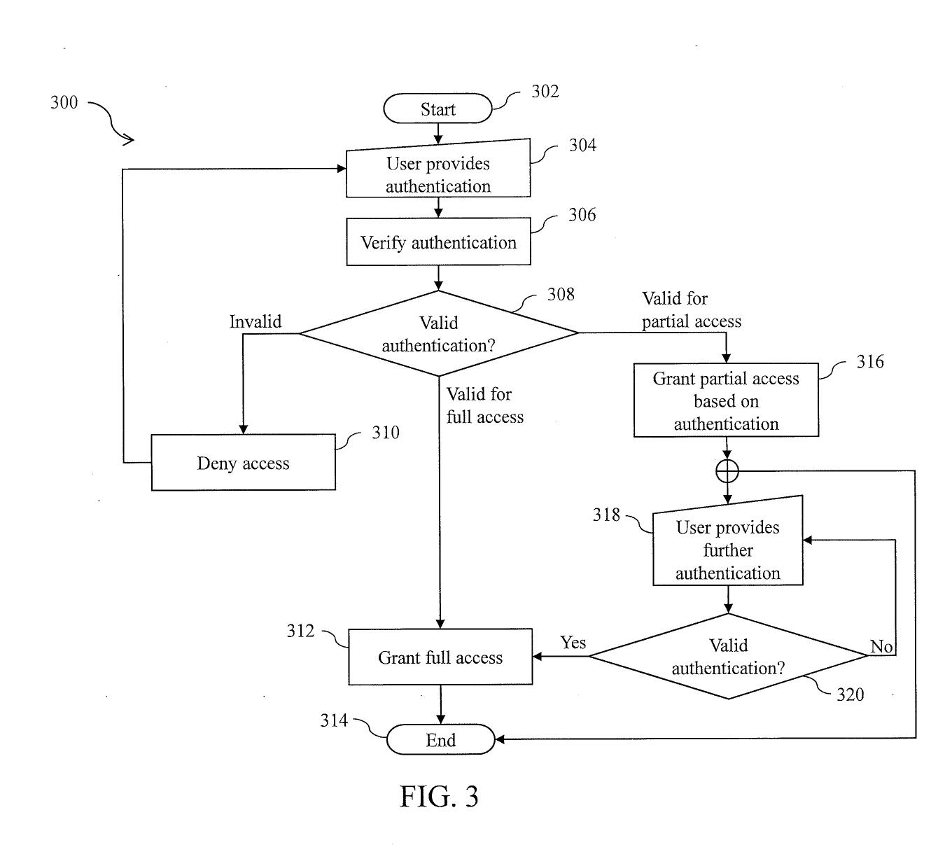

Referring now to FIG. 3, a flowchart of a method 300 for access control based on length or type of authentication is illustrated according to an embodiment of the present disclosure.

At block 302, user 102 decides to unlock user device 120 to access an application or functionality on user device 120.

At block 304, user 102 provides an authentication to unlock user device 120. Access control program 124 receives and/or accesses the provided authentication. Depending on user settings/configuration, user 102 may, for example, enter a password on touchscreen 222 or a keyboard, draw a swipe pattern on touchscreen 222, tap a pattern on touchscreen 222, scan a fingerprint on fingerprint identity sensor 142, scan a retinal pattern on a retinal scanner, speak into a microphone, or present a face on camera 144.

At block 306, access control program 124 verifies the authentication provided by user 102 based on authentication information previously established by user 102 and, at block 308, decides whether the provided authentication is valid. In an embodiment, user 102 establishes two or more authentications that are of different length or type from one another. Each of the authentications that are previously established by user 102 is valid. The established authentications may include one or more authentications for full access and one or more authentications for partial access. User 102 associates each established authentication with a level of access. Thus, the provided authentication may be valid for full access, valid for one or more levels of partial access, or invalid.

At block 310, access control program 124 denies access based on a provided authentication that is invalid, for example a password that does not match the established password or a fingerprint that is not recognized as that of an authorized user. User 102 may then try again to provide a valid authentication.

At block 312, access control program 124 grants full access based on a provided authentication that is valid for full access. When user 102 provides the full access authentication, user 102 is granted access to all applications and functionalities on user device 120. Once user 102 is granted full access, the access control may end 314.

In various embodiments, the full access authentications may include, for example, a full password, full swipe pattern, biometric, etc. In certain embodiments, user 102 may select and/or establish two or more full access authentications that are of different types from one another. If two or more full access authentications are established, those authentications may be provided in the alternative to gain full access. For example, user 102 may configure access control program 124 to grant full access when either a full password is entered, or alternatively when a fingerprint is scanned on fingerprint identity sensor 142.

In some embodiments, one of the full access authentications may include a combination of two or more authentication types. For example, one full access authentication may include a full password, and another full access authentication may include a combination of a partial password and a swipe pattern, such that the combination is equivalent to the full password. For full access, user 102 may provide the full password, or the partial password together with the swipe pattern.

At block 316, access control program 124 grants partial access based on a provided authentication that is valid for partial access. In an embodiment, user 102 may establish two or more partial access authentications that are of different length and/or type from one another, and associate each partial access authentication with an access level. When user 102 provides one of the partial access authentications, user 102 is granted access at the access level associated with that partial access authentication. User 102 may decide that the current access level is sufficient, and the access control may end 314.

In various embodiments, access control program 124 determines the access level to grant to user 102 based on the length of authentication provided by user 102. The partial access authentications may vary in length, such as a length of a password or a length of a swipe pattern, and match a part of a full access authentication. A partial password for a password may be the first/last few digits/characters of the full password. For example, if the full password is an 8 digit/character password, the partial passwords may be the first 2 digits/characters and the first 4 digits/characters, each providing a different level of access. A partial swipe pattern for a swipe pattern may be one or more swipes of a full swipe pattern. For example, if the full swipe pattern is to draw 5 lines on a pattern entry screen, the partial swipe patterns may be the first line and the first 3 lines of the full swipe pattern.

In other embodiments, access control program 124 determines the access level to grant based on the type of authentication. For example, user 102 may be granted full access if user 102 authenticates with a fingerprint, intermediate access if user 102 authenticates with a password, and basic access if user 102 authenticates with a swipe pattern. In further embodiments, access control program 124 determines the access level based on both the length and type of authentication.

In some embodiments, the full access authentication may include a combination of two or more authentication types, and the partial access authentications may include each of the authentication types individually. The two or more authentication types together provide full access, while each authentication type individually provides partial access. In an example, the full access authentication may include a combination of a partial password and a swipe pattern. User 102 may be granted partial access by providing the partial password by itself, the level of access depending on the length, or the swipe pattern by itself.

In an embodiment, when user 102 is granted partial access, only the applications that user 102 has access to are shown. In other embodiments, when user 102 is granted partial access, all applications on user device 120 are shown, but only certain applications are accessible and/or able to be launched. In further embodiments, the applications that are not accessible are differentiated from the accessible applications, for example, by greying out or by making semi-transparent.

At block 318, user 102 may decide that he or she wants access to applications and/or functionalities that are not available at the current access level and provide additional authentication.

At block 320, access control program 124 determines whether the additional authentication provided by user 102 is valid. Each authentication that is previously established by user 102 is valid. The additional authentication may be a longer authentication (e.g., a longer partial password or a longer swipe pattern), or a different type of authentication. The additional authentication may be an authentication for a higher access level, or a full access authentication that provides full access, at block 312.

In various embodiments, while user 102 has partial access, user 102 may provide a full access authentication (e.g., a full password or a fingerprint scan) to obtain full access. For example, when user 102 attempts to access an application that is not accessible at the current access level, a password entry screen or a pattern entry screen may automatically be presented for user 102 to enter the full password or pattern. In another example, user 102 may scan a fingerprint on fingerprint identity sensor 142 at any time for full access.

In some embodiments, access control program 124 provides a two-factor authentication function. If one of the full access authentications includes a combination of two authentication types and user 102 provided the first authentication type for partial access, user 102 may provide the second authentication type for full access. For example, if the full access authentication is a combination of a partial password and a swipe pattern and user 102 provided the partial password for partial access, user 102 may then enter the swipe pattern for full access.

In an embodiment, if the additional authentication is invalid, user 102 is denied further access and may then try again to provide a valid authentication. In other embodiments, if the additional authentication is invalid, user device 120 is locked and user 102 must start over at block 302. In further embodiments, user 102 has a predetermined number of tries to enter a valid further authentication before user device 120 is locked.

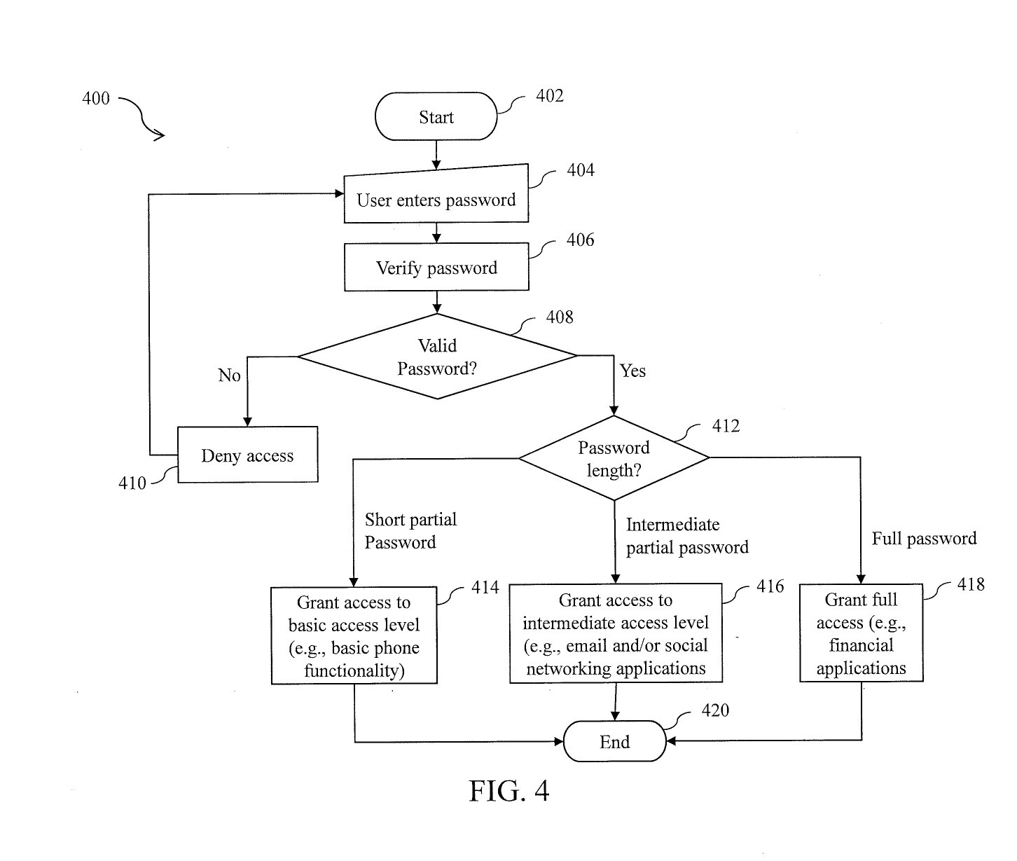

Referring now to FIG. 4, a flowchart of a method 400 for granting tiered access based on a length of a password is illustrated according to an embodiment of the present disclosure. The password may be a PIN, a passphrase, an alphanumeric password, etc. The password may include letters, numbers, and/or other types of characters such as symbols (e.g., punctuation marks, emoticons, etc.). In some embodiments, the password consists of two to sixteen characters, although different password lengths are also possible.

In various embodiments, when user 102 enters a password that is a full or partial match with a full length password, access control program 124 allows user 102 to access different applications and/or functionalities based on the length of the provided password. The full length password and/or one or more valid partial passwords are previously established by user 102 through user settings/configuration. The valid partial passwords may be partial passwords of predetermined lengths (e.g., the first 2 digits/characters), or partial passwords within a range of lengths (e.g., 2-3 digits/characters).

In some embodiments, access control program 124 allows user 102 to access different applications further based on the location of the provided partial password within the full password. The valid partial passwords may have a predetermined location within the full length password (e.g., at beginning, at end, or some interior portion). Further, two or more valid partial passwords may have different locations from each other. For example, for a password of G!@mbillMK#2, a partial password of “bill” may provide one type of access, which may be desirable over the first four digits/characters because “bill” is easier for the user to remember and enter.

In many embodiments, the partial passwords are associated with an access level. User 102 may preset one or more access levels, and which applications and/or functionalities are available at each access level. For example, user 102 may set three access levels, such as basic access, intermediate access, and full access. One or more short partial passwords may be associated with basic access, one or more intermediate partial passwords may be associated with intermediate access, and the full length password may be associated with full access. The partial passwords for each access level may be of determined length or within a range.

At block 402, user 102 decides to unlock user device 120 by entering a password to access an application or functionality on user device 120.

At block 404, user 102 enters a password. Access control program 124 receives and/or accesses the password entered by user 102.

At block 406, access control program 124 verifies the entered password based on the full length password and, at block 408, decides whether the entered password is valid. The entered password is valid if it matches the full length password or a part of the full length password. The entered password is invalid if it does not match the full length password or a part of the full length password.

At block 410, if the entered password is invalid, access control program 124 denies access to user 102.

At block 412, access control program 124 decides the access level to grant to user 102 based on the length of the entered password. When user 102 enters a partial password that is short (e.g., the first 2 digits/letters of an 8 digit/letter full password), access control program 124 may grant a lower level of access in which user 102 is able to access less applications and/or functionalities. When user 102 enters a partial password that is longer (e.g., the first 4 digits/letters of an 8 digit/letter full password), access control program 124 grants a higher level of access in which user 102 is able to access more applications and/or functionalities.

At block 414, if the entered password is a short partial password, such as the first 2 digits/characters of the full length password, access control program 124 grants basic access. The basic access level may allow access to basic phone functionality such as SMS texting and/or calling. The basic access level may also allow access to applications that contain no private or sensitive information, such as game applications.

At block 416, if the entered password is an intermediate partial password, such as the first 4 digits/characters of the full length password, access control program 124 grants intemiediate access. The intermediate access level may allow access to certain applications preselected by user 102. For example, user 102 may be granted access to email applications (e.g., Gmail™), social media applications (e.g., Twitter™), and/or chat applications (e.g., WhatsApp™). The intermediate access level may allow access to specific functionalities of user device 102 or specific functionalities of an application. For example, user 102 may be granted access to reading emails but not to composing and sending email messages on an email application.

At block 418, if the entered password is the full length password, access control program 124 grants full access. The full access level may grant access to all applications and/or functionality. For example, user 102 may be granted access to financial applications (e.g., Mint.com™ App, E*TRADE™ App, etc.) and/or banking applications (Chase Mobile® App) that contain sensitive financial information.

At block 420, user 102 has been granted access and the access control may end.

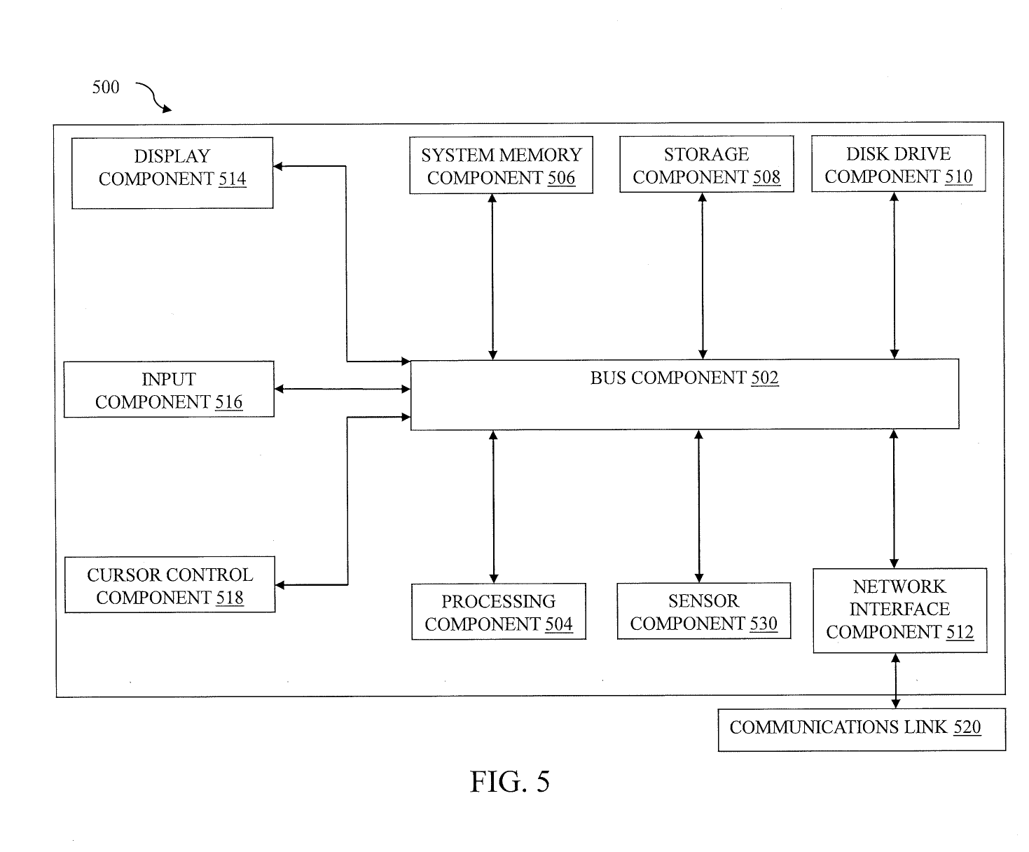

Referring now to FIG. 5, a block diagram of a system 500 is illustrated suitable for implementing embodiments of the present disclosure, including user device 120 and service provider server or device 180. System 500, such as part of a cell phone, a tablet, a personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), a cursor control component 518 (e.g., a mouse pad), and a sensor component 530 (e.g., fingerprint identity sensor, camera, etc.).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to receive an authentication, verify the authentication, grant access to applications and functionalities based on the length and type of the authentication, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching, auto-synchronizing, storing access control information, making payments, or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., network 160 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for access control on a user device based on length or type of authentication.

Although various components and steps have been described herein as being associated with user device 120 and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory storing authentication information established by a user comprising a plurality of authentications for unlocking a user device, each of the authentications associated with one of a plurality of access levels based, at least in part, on a length of each of the authentications, wherein at least one of the authentications is associated with an account maintained by a service provider server; and
one or more hardware processors coupled to the non-transitory memory to cause the system to perform operations comprising:
receiving an authentication to unlock the user device provided by the user on a lock screen of the user device;
verifying the provided authentication based on the established authentication information;
granting access to applications, functionalities, or both on the user device that are accessible at an access level associated with the provided authentication; and
in response to determining the provided authentication is associated with the account, automatically logging in to the account on the service provider server.

2. The system of claim 1, wherein each of the authentications is associated with the one of the plurality of access levels further based on a type of each of the authentications.

3. The system of claim 1, wherein the plurality of the access levels comprises a full access level for full access and one or more partial access levels for partial access, and wherein the plurality of the authentications comprises one or more full access authentications each associated with the full access level, and one or more partial access authentications each associated with one of the partial access levels.

4. The system of claim 1, wherein at least one of the applications, functionalities, or both are predetermined to be accessible or inaccessible at each of the access levels.

5. The system of claim 1, wherein two or more of the applications, functionalities, or both are grouped into categories, and wherein each of the categories is associated with at least one of the access levels.

6. The system of claim 1, wherein the operations further comprise:
receiving an additional authentication provided by the user on the user device;
verifying the provided additional authentication based on the established authentication information; and
granting further access at a higher access level associated with the provided additional authentication.

7. The system of claim 6, wherein the provided additional authentication is longer in length or of a different type than the provided authentication.

8. The system of claim 3, wherein the plurality of the authentications comprises a full length password and one or more partial passwords of the full length password, and wherein the provided authentication comprises a password entered by the user.

9. The system of claim 8, wherein the full length password is associated with the full access level, and wherein each of the partial passwords are associated with one of the partial access levels based on a length of each of the partial passwords that is matched to the full length password.

10. The system of claim 1, wherein the operations further comprise receiving, automatically via push synchronization, access control information comprising the established authentication information and access control rules from an access control service provider server, wherein the access control rules comprise the plurality of access levels and associations between the plurality of authentications and the plurality of access levels.

11. A method for providing access control, comprising:
receiving, by one or more processors, an authentication to unlock a user device provided by a user on a lock screen of the user device;
accessing, by the one or more processors, authentication information established by the user comprising a plurality of authentications for unlocking the user device, each of the authentications associated with one of a plurality of access levels based, at least in part, on a length or type of each of the authentications, wherein at least one of the authentications is associated with an account maintained by a service provider;
verifying, by the one or more processors, the provided authentication based on the authentication information established by the user;
determining, by the one or more processors, an access level associated with the provided authentication;
granting, by the one or more processors, access to applications, functionalities, or both that are accessible at the determined access level;
in response to determining the provided authentication is associated with the account, automatically logging in to the account on the service provider server.

12. The method of claim 11, wherein the plurality of access levels comprises a full access level for full access and one or more partial access levels for partial access, wherein the plurality of authentications comprises one or more full access authentications each associated with the full access level and one or more partial access authentications each associated with one of the partial access levels, and wherein each of the authentications is of a different length or type from one another.

13. The method of claim 11, each of the applications, functionalities, or both are predetermined to be accessible or inaccessible at each of the access levels.

14. The method of claim 11, wherein categories of the applications, functionalities, or both are predetermined, and wherein each of the categories is associated with at least one of the access levels.

15. The method of claim 12, wherein the at least one of the authentications associated with the account comprises at least one of the full access authentications.

16. The method of claim 11, further comprising:
receiving, by the one or more processors, an additional authentication provided by the user on the user device; and
verifying, by the one or more processors, the provided additional authentication based on the established authentication information; and
granting, by the one or more processors, further access to applications, functionalities, or both at a higher access level associated with the provided additional authentication.

17. The method of claim 12, wherein the the plurality of authentications comprises a full length password and one or more partial passwords of the full length password, and wherein the provided authentication is a password entered by the user.

18. The method of claim 17, wherein the full length password is associated with the full access level, and wherein each of the partial passwords is associated with the one of the partial access levels based on a length, a location within the full length password, or both of each of the partial passwords.

19. A non-transitory machine-readable medium having stored thereon machine-readable instructions executable to cause a machine to perform operations comprising:
receiving a password to unlock a user device entered by a user on a lock screen of the user device;
accessing password information established by the user comprising a plurality of passwords for unlocking the user device, each of the passwords associated with one of a plurality of access levels based, at least in part, on a length of each of the passwords, wherein the plurality of passwords comprise a full length password for full access and one or more partial passwords of the full length password for partial access, and wherein at least one of the passwords is associated with an account maintained by a service provider;
verifying the entered password based on the password information;
granting access to applications, functionalities, or both that are accessible at an access level associated with the entered password; and
in response to determining the entered password is associated with the account, automatically logging in to the account on the service provider server.

20. The non-transitory machine-readable medium of claim 19, wherein a plurality of the applications, functionalities, or both are predetermined to be accessible or inaccessible at each of the access levels.
